(19) United States
(12) Patent Application Publication
(10) Pub. No.: US 2026/0272206 A1
(43) Pub. Date: Sep. 17, 2026

(54) SOAK TANK OVERFLOW MANAGEMENT

(71) Applicant: Heat and Control, Inc., Flower Mound, TX (US)

(72) Inventors: Victor MANKARIOUS, Flower Mound, TX (US); Rick Wendell BAJEMA, Flower Mound, TX (US); Jonathan Daniel KAYLOR, Flower Mound, TX (US)

(21) Appl. No.: 19/566,759

(22) Filed: Mar. 13, 2026

Related U.S. Application Data
(60) Provisional application No. 63/772,350, filed on Mar. 14, 2025.

(51) Int. Cl. A47J 27/18; A47J 27/12; A47J 27/21; A47J 36/32

(52) U.S. Cl. CPC A47J 27/18; A47J 27/12; A47J 27/21183; A47J 36/32

(57) ABSTRACT

A system for managing fluid overflow in a food cooking process is provided. The system includes one or more kettles, one or more soak tanks, and an overflow tank. The soak tanks receive a cooked food product mixture from the kettles and have overflow piping connected to the overflow tank. The overflow tank receives the excess fluid product mixture and separates fluid from sinking and floating debris and delivers the fluid to a first valve. The first valve transmits the fluid to the overflow tank for agitation to prevent fouling or transmits the fluid to a second valve. The second valve recycles the fluid back to the one or more kettles for cooking or diverts the fluid to the overflow piping for cleaning.

### CROSS-REFERENCE TO RELATED APPLICATIONS

This application claims the benefit of provisional U.S. Application No. 63/772,350 entitled “Soak Tank Overflow Management” filed Mar. 14, 2025, the technical disclosure of which is incorporated herein by reference in its entirety.

### BACKGROUND

### Technical Field

The technical field of the present disclosure relates to industrial food process engineering and, more particularly, to water and energy management in corn processing systems that are common for snack food production.

### Description of Related Art

The existing technology for managing soak tank overflow (STO) in cooking systems often involves inefficient methods that lead to significant water and energy waste. Traditional systems do not recycle overflow water, resulting in high operational costs and environmental impact. Additionally, these systems can suffer from lime buildup, which requires frequent maintenance and can disrupt operations. Ensuring compliant (or complete) sanitization without excessive water use is another challenge, as is the removal of debris (e.g., corn cob and stalk) that can clog the system. Therefore, a need exists for an improved STO system that reduces energy consumption and water usage and ensures compliant sanitization of the cooking system.

### BRIEF SUMMARY

This summary provides a discussion of aspects of certain embodiments of the invention. It is not intended to limit the claimed invention or any of the terms in the claims. The summary provides some aspects but there are aspects and embodiments of the invention that are not discussed here.

In one embodiment, a system for managing fluid overflow in a food cooking system comprises one or more kettles configured to contain a fluid for cooking a food product, one or more soak tanks comprising a first inlet, a first outlet, and overflow piping, wherein the first inlet is fluidly connected to an outlet of the one or more kettles and configured to receive a cooked food product mixture, and wherein the first outlet is fluidly connected to the overflow piping, and an overflow tank comprising a first inlet, a second inlet, and a first outlet, wherein the first inlet is fluidly connected to the overflow piping, the first outlet is fluidly connected to an inlet of a first valve, and the second inlet is fluidly connected to a first outlet of the first valve, further wherein the overflow tank is configured to: receive an excess amount of fluid from the one or more soak tanks via the overflow piping, wherein the excess amount of fluid comprises the fluid and debris, separate the fluid from the debris, and deliver the separated fluid to the first valve, wherein the first valve is configured to: selectively deliver the separated fluid to an inlet of a second valve having a first outlet and a second outlet, wherein the first outlet of the second valve is fluidly connected to an inlet of the one or more kettles, and the second outlet of the second valve is fluidly connected to the overflow piping, wherein the second valve is configured to: selectively deliver the separated fluid to the one or more kettles for subsequent cooking, or selectively deliver the separated fluid to the overflow piping for cleaning, and a third valve and a collection box, wherein an inlet of the third valve is fluidly connected to a second outlet of the overflow tank, an outlet of the third valve is fluidly connected to a first inlet of the collection box, and wherein the overflow tank comprises a debris monitor, further wherein the third valve is configured to selectively deliver debris to the collection box when the debris monitor detects a threshold amount of debris in the overflow tank.

In another embodiment, the system further comprises a fourth valve having an inlet fluidly connected to the overflow piping, a first outlet fluidly connected to the first inlet of the overflow tank and a second outlet fluidly connected to a second inlet of the collection box, wherein the fourth valve is configured to: selectively deliver the excess amount of fluid to the overflow tank or selectively deliver the excess amount of fluid to the collection box.

In another embodiment, the system further comprises a fifth valve having an inlet, a first outlet, and a second outlet, wherein the inlet of the fifth valve is fluidly connected to the first outlet of the second valve, further wherein the one or more kettles comprises a first kettle and a second kettle, an inlet of the first kettle being fluidly connected to the first outlet of the fifth valve, and an inlet of the second kettle being fluidly connected to the second outlet of the fifth valve, and further wherein the fifth valve is configured to selectively deliver the separated fluid to the first kettle, the second kettle, or a combination thereof.

In another embodiment, the one or more soak tanks comprises a first set of soak tanks and a second set of soak tanks, the first set of soak tanks comprising multiple soak tanks, and the second set of soak tanks comprising multiple soak tanks, wherein the first set of soak tanks are in fluid communication with the first kettle and the overflow tank, and wherein the second set of soak tanks are in fluid communication with the second kettle and the overflow tank.

In another embodiment, a third outlet of the overflow tank is in fluid communication with a third inlet of the collection box, further wherein the overflow tank is configured to discharge a portion of the excess amount of fluid when a volume of the excess fluid exceeds a threshold amount.

In another embodiment, the overflow tank further comprises a movable baffle disposed at a bottom portion within the overflow tank, and wherein the movable baffle is configured to prevent the debris from exiting the first outlet of the overflow tank.

In another embodiment, when the second valve selectively delivers the separated fluid to the overflow piping, the one or more soak tanks are partially filled.

In another embodiment, the overflow tank is configured to receive a cleaning solution to deliver to the overflow piping.

In another embodiment, the debris monitor detects a predetermined amount of debris, further wherein a transfer of food product from the one or more kettles to the one or more soak tanks is terminated, and further wherein an alarm is triggered indicating a malfunction in the system.

In one embodiment, a system for managing fluid overflow in a food cooking system comprises one or more kettles configured to contain a fluid for cooking a food product, one or more soak tanks comprising a first inlet, a first outlet, and overflow piping, wherein the first inlet is fluidly connected to an outlet of the one or more kettles and configured to receive a cooked food product mixture, and wherein the first outlet is fluidly connected to the overflow piping, and an overflow tank comprising a first inlet, a second inlet, a first outlet, a second outlet, and a debris monitor, wherein the first inlet is fluidly connected to the overflow piping and configured to receive an excess amount of fluid from the one or more soak tanks via the overflow piping, wherein the excess amount of fluid comprises the fluid and debris, and wherein the overflow tank is configured to separate the fluid from the debris, a first valve comprising an inlet, a first outlet, and a second outlet, wherein the inlet of the first valve is fluidly connected to the first outlet of the overflow tank, the first outlet of the first valve is fluidly connected to the second inlet of the overflow tank, a second valve fluidly connected to the second outlet of the first valve, wherein a first outlet of the second valve is fluidly connected to an inlet of the one or more kettles, and a second outlet of the second valve is fluidly connected to the overflow piping, a third valve comprising an inlet and an outlet, wherein the inlet is fluidly connected to the second outlet of the overflow tank, a collection box fluidly connected to the outlet of the third valve, and wherein the first valve is configured to: selectively deliver the separated fluid to the second valve, wherein the second valve is configured to: selectively deliver the separated fluid to the one or more kettles for subsequent cooking, wherein the third valve is configured to selectively deliver debris to the collection box when the debris monitor detects a threshold amount of debris in the overflow tank.

In another embodiment, the system comprises a fourth valve having an inlet fluidly connected to the overflow piping, a first outlet fluidly connected to the first inlet of the overflow tank, and a second outlet fluidly connected to the collection box, wherein the fourth valve is configured to: selectively deliver the excess amount of fluid to the overflow tank; or selectively deliver the excess amount of fluid to the collection box.

In another embodiment, the system further comprises a fifth valve having an inlet, a first outlet, and a second outlet, wherein the inlet of the fifth valve is fluidly connected to the first outlet of the second valve, further wherein the one or more kettles comprises a first kettle and a second kettle, an inlet of the first kettle being fluidly connected to the first outlet of the fifth valve, and an inlet of the second kettle being fluidly connected to the second outlet of the fifth valve, and further wherein the fifth valve is configured to selectively deliver the separated fluid to the first kettle, the second kettle, or a combination thereof.

In another embodiment, the one or more soak tanks comprises a first set of soak tanks and a second set of soak tanks, the first set of soak tanks comprising multiple soak tanks, and the second set of soak tanks comprising multiple soak tanks, wherein the first set of soak tanks are in fluid communication with the first kettle and the overflow tank, and wherein the second set of soak tanks are in fluid communication with the second kettle and the overflow tank.

In another embodiment, the overflow tank further comprises a third outlet in fluid communication with the collection box, wherein the overflow tank is configured to discharge a portion of the excess amount of fluid when a volume of the excess fluid exceeds a threshold amount.

In another embodiment, the overflow tank further comprises a movable baffle disposed at a bottom portion within the overflow tank, and wherein the movable baffle is configured to prevent the debris from exiting the first outlet of the overflow tank.

In another embodiment, when the second valve selectively delivers the separated fluid to the overflow piping, the one or more soak tanks are partially filled, and the overflow tank is configured to receive a cleaning solution to deliver to the overflow piping.

In another embodiment, the debris monitor detects a predetermined amount of debris, further wherein a transfer of food product from the one or more kettles to the one or more soak tanks is terminated, and further wherein an alarm is triggered indicating a malfunction in the system.

### BRIEF DESCRIPTION OF THE DRAWINGS

The preceding aspects and many of the attendant advantages of the present technology will become more readily appreciated by reference to the following Detailed Description when taken in conjunction with the accompanying simplified drawings of example embodiments. The drawings briefly described below are presented for ease of explanation and do not limit the scope of the claimed subject matter.

FIG. 1 depicts a simplified process flow diagram of a cooking system.

FIG. 2 depicts a simplified process flow diagram of a system for managing fluid overflow in a cooking system.

FIG. 3 depicts a schematic of a system for managing fluid overflow in a cooking system.

FIG. 4 depicts a schematic of a spiral nozzle for sanitizing overflow piping in a cooking system.

FIG. 5 depicts an overflow tank for use in a system for managing fluid overflow in a cooking system.

FIG. 6 depicts a schematic of an overflow tank for use in a system for managing fluid overflow in a cooking system.

FIG. 7 depicts a diagram of kettles for use in a system for managing fluid overflow in a cooking system.

FIG. 8 depicts a series of soak tanks for use in a system for managing fluid overflow in a cooking system.

FIG. 9 depicts a schematic of soak tanks connected to an overflow tank.

### DETAILED DESCRIPTION

The present disclosure involves systems and methods that improve the efficiency and sustainability of food industrial processes, including managing soak tank overflow in corn cooking operations. However, the disclosed systems and methods can be applied to any food product. As described herein, the present disclosure provides efficient and optimal management of soak tank overflow in corn cooking systems. For example, the described systems and methods can significantly reduce water and energy consumption by utilizing novel recycling of overflow water back into the corn cooking process. The systems can include an agitation system (or loop) to prevent lime buildup and incorporate a low-level sanitation loop to maintain hygiene without filling the soak tanks completely. Timed and sensed purges can effectively remove debris, ensuring smooth operation. The disclosed systems can be integrated with existing programmable logic controllers (PLC) and human-machine interface (HMI) systems, minimizing installation costs. The disclosed systems offer a cost-effective, efficient, and sustainable solution for managing soak tank overflow.

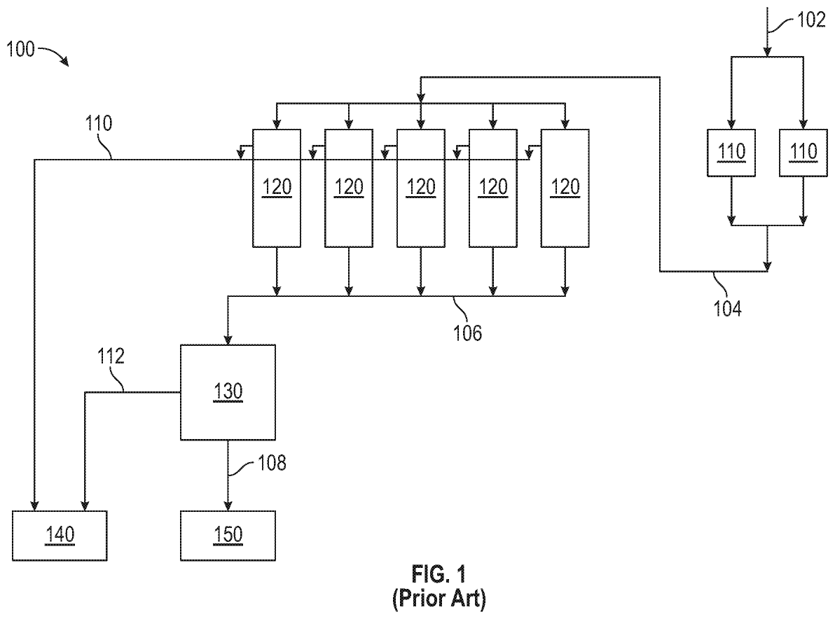

Turning to FIG. 1, a simplified process flow diagram of a prior art corn cooking system 100 is depicted. The corn cooking system includes a set of kettles 110, a set of soak tanks 120, a corn washer 130, a collection box 140, and a mill 150. The set of kettles 110 receives a cooking mixture 102 (e.g., corn and water) to cook the corn for subsequent processing. Additionally, lime can be added directly to the set of kettles 110 for cooking the mixture. The cooked corn mixture 104 is delivered to a set of soak tanks 120 to allow the corn to rehydrate, loosen hulls, and develop flavor. The excess fluid in the soak tanks 120 is drained 110 to the collection box 140, and the hydrated corn mixture 106 is then delivered to a corn washer 130, where the corn is separated from the hulls and lime. The unwanted debris 112 (e.g., hulls and lime) are then delivered to the collection box 140. The separated corn 108 is delivered to the mill 150 for further processing (e.g., baking or frying).

Although the process 100 described in FIG. 1 is widely used in the industry, the process has several deficiencies that negatively impact the water and energy resources used to employ the process 100. For example, the process 100 typically requires a fresh source of water to be delivered to the kettles 110 for each cooking batch. Additionally, the process 100 is typically modified to utilize cyclone separators or hydrosieves to separate excess fluid from the soak tanks 120 to recycle into the system 100. However, these separator components require multiple pumps or additional energy inputs to accomplish the desired water recycling. In contrast, the disclosed systems and methods address these deficiencies by utilizing an overflow tank that efficiently recycles the water resources without requiring additional energy inputs, and optimizes the sanitary conditions of the process.

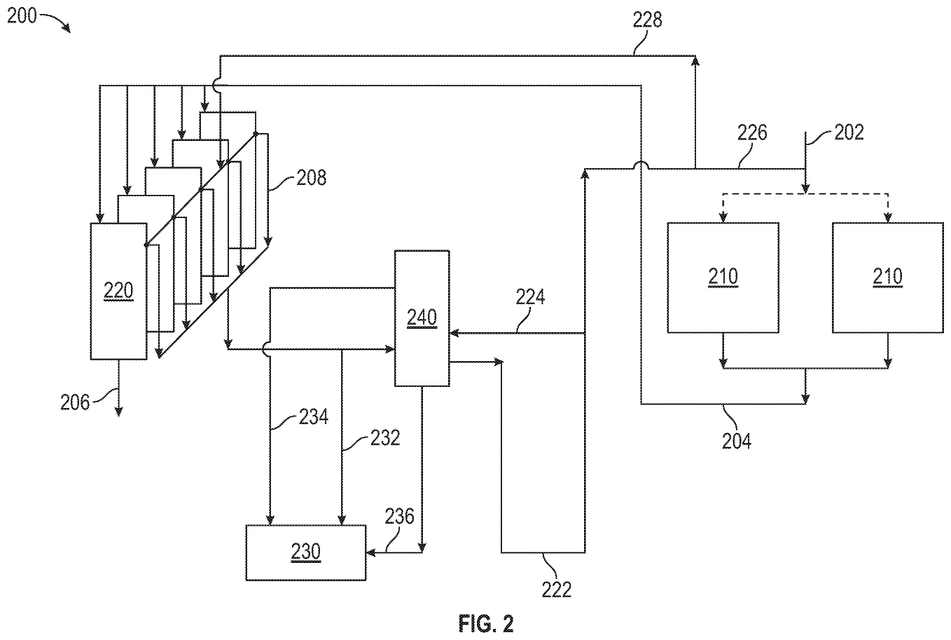

Turning to FIG. 2, a simplified process flow diagram of a system 200 for managing fluid overflow in a cooking system is depicted. The system 200 includes a set of kettles 210, a set of soak tanks 220, an overflow tank 240, and a collection box (or alternatively referred to as a separation box or drainage box) 230. Although the illustrative embodiment depicts the set of kettles 210 as two kettles, the set of soak tanks 220 as five tanks, and the collection box 230 as one collection box, the number of these components can vary. The process can begin with the set of kettles 210 receiving a cooking mixture 202 that can include corn, water, and lime. Once sufficiently cooked, the cooked mixture product 204 can be delivered to the set of soak tanks 220 to allow the corn to rehydrate, loosen hulls, and develop flavor. Like the conventional process 100 depicted in FIG. 1, the hydrated corn mixture 206 can be delivered to a corn washer (not illustrated), where the corn is separated from the hulls and lime. Like the conventional process 100 depicted in FIG. 1, the set of soak tanks 220 are configured with overflow piping 208 that allows excess fluid to be drained or diverted to a recycling system. However, the system 200 utilizes a novel overflow tank 240 system that improves the recycling of excess fluid.

As explained in more detail below, the overflow tank 240 can be configured to output 222 the excess fluid for various circulation loops in the system 200. In one example, the overflow tank 240 can be configured for a cooking loop wherein the excess fluid 222 is transported out of the overflow tank 240 and recycled 226 back to the set of kettles 210 for subsequent cooking. The cooking loop provides the added benefits of minimizing the need for fresh water supply to cook the corn in the kettles 210. Additionally, when the hydrated corn mixture does not pass through a corn washer, the recycled water contains lime from previous cooking cycles and advantageously decreases the need to add lime to the kettles 210 for cooking. The recycled water also has an elevated temperature compared to service water delivered to the kettles 210, which saves energy to reach the cooking temperature in the kettles 210. The excess fluid 226 can be recycled back to the set of kettles 210 at a flow rate of 70-120 gpm, 80-110 gpm, 90-100 gpm, at least 70 gpm, 80 gpm, 90 gpm, 100 gpm, or any combination thereof. The amount of recycled water could be between 5-50% of the water needed.

In another example, the overflow tank 240 can be configured to output 222 the excess fluid for an agitation loop to prevent fouling within the overflow tank 240. After the overflow tank 240 outputs 222 the excess fluid, an agitation valve (not illustrated) diverts 224 the excess fluid back to the overflow tank 240 where agitation nozzles (not illustrated) agitate the excess fluid stored in the overflow tank 240, which prevents the particulates from settling and fouling the overflow tank (e.g., lime build-up in the interior of the overflow tank), and increases the sanitation effectiveness of the process 200. The excess fluid 224 can be recycled back to the overflow tank 240 at a flow rate of 10-70 gpm, 20-60 gpm, 30-50 gpm, at least 10 gpm, 20 gpm, 30 gpm, 40 gpm, 50 gpm, 60 gpm, 70 gpm, or any combination thereof. It is important to maintain the excess fluid 224 below a high flow rate to prevent excessive agitation that projects the particulates toward the top of the overflow tank 240 or into the recycling loop 222. Instead, the excess fluid 224 flow rate preferably agitates the fluid in the overflow tank to prevent the particulates from settling.

In yet another example, the overflow tank 240 can also be configured to output 222 a cleaning solution for a sanitizing loop to clean the overflow piping 208. A cleaning solution can be dumped into the overflow tank 240, which outputs 222 the cleaning solution to a fill valve (not illustrated), where the cleaning solution is diverted 228 to the overflow piping 208 for cleaning, enhancing the sanitation of the system 200. The sanitizing loop is preferably performed as a low-level (or low point) sanitization loop that does not require the soak tanks 220 to be filled and the overflow tank 240 only needs to be partially filled. Thus, the sanitizing loop advantageously utilizes a smaller amount of energy, water, and resources to sanitize the overflow piping. The cleaning solution 228 can be recycled back to the overflow piping 208 at a flow rate of 10-70 gpm, 20-60 gpm, 30-50 gpm, at least 10 gpm, 20 gpm, 30 gpm, 40 gpm, 50 gpm, 60 gpm, 70 gpm, or any combination thereof. Given the wide variance in flow rates between the different circulation loops, the overflow tank 240 is preferably not pressurized to allow the system to easily transition between the various flow rates.

The overflow tank can also be configured to divert the excess fluid to the separation box 230 to avoid the build-up of debris in the overflow tank 240. For example, before the excess fluid enters the overflow tank 240, the excess fluid can be diverted 232 to the collection box 230. This diverted flow pattern 232 can be utilized in situations where there might be a malfunction in the system and the water needs to be discharged from the system. The overflow tank 240 can be configured to determine a threshold level (or amount) of debris that has been collected in the settling chamber (not illustrated) in the bottom of the overflow tank 240 and drain the debris 236 to the collection box 230. The collection box 230 can include perforations that are configured to retain the debris and pass the water to the drain or wastewater treatment facility. The overflow tank 240 can be configured to drain the excess fluid 234 upon the excess fluid 234 exceeding a threshold level in the overflow tank 234. The overflow configuration of the overflow tank 240 enables the floating debris (e.g., cob and stalk) to be removed with the overflow 234.

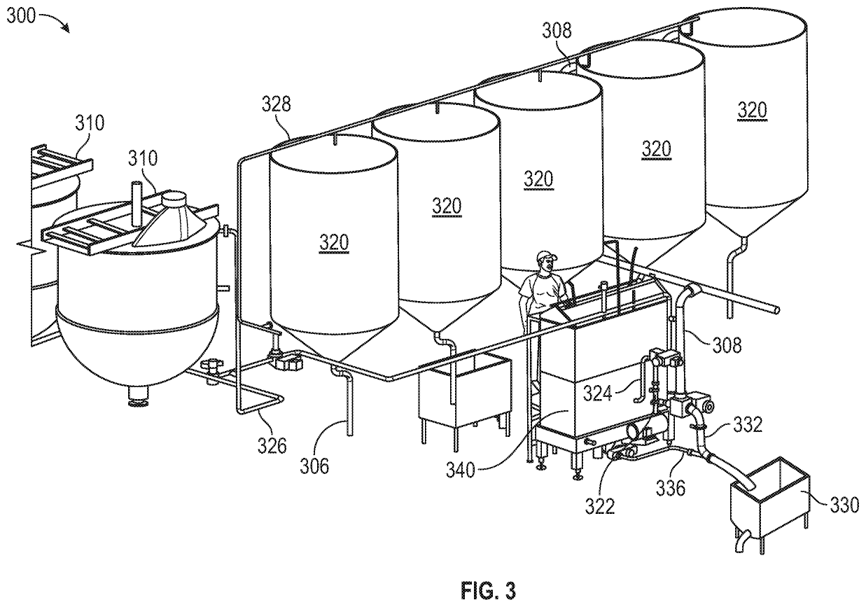

Turning to FIG. 3, a schematic of the circulation loops in a system 300 for managing fluid overflow in a cooking system is depicted. Like the system depicted in FIG. 2, the system 300 includes a set of kettles 310, a set of soak tanks 320, an overflow tank 340, and a separation box 330. The overflow piping 308 allows the excess fluid contained in the set of soak tanks 320 to be delivered to the overflow tank 340. The hydrated corn mixture 306 can be delivered to a corn washer (not illustrated), where the corn is separated from the hulls and lime.

Once the excess fluid exits the overflow tank 340 and enters a pump, the excess fluid 322 can be recycled 324 back to the overflow tank 340 to agitate the contained excess fluid. Additionally, or alternatively, the excess fluid 322 can be recycled 326 back to the set of kettles 310 for subsequent cooking. Additionally, or alternatively, the overflow tank 340 can be configured to deliver a cleaning solution 328 to the overflow piping 308 for sanitation purposes. Additionally, or alternatively, the overflow tank 340 can be configured to divert the excess fluid 332 to the collection box 330. Additionally, or alternatively, the overflow tank 340 can be configured to determine a threshold level of debris that has been collected in the settling chamber (not illustrated) of the overflow tank 340 and drain the debris 336 to the collection box 330. Additionally, or alternatively, the overflow tank 340 can be configured to drain the debris 336 to the collection box 330 based on a predetermined amount of time elapsing, or at a predetermined time interval.

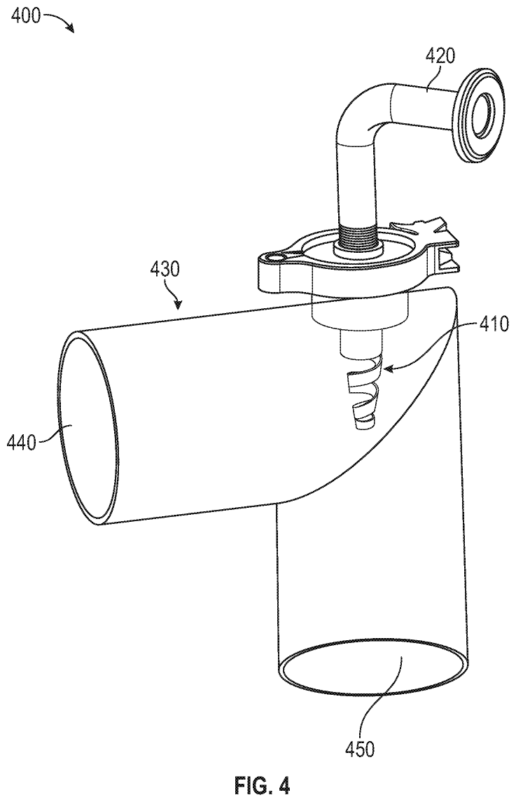

With reference to FIG. 4, a schematic 400 of a spiral nozzle 410 for sanitizing overflow piping 430 in a corn cooking system is depicted. In the illustrative embodiment, the spiral nozzle 410 is installed in the overflow piping 430 and configured to sanitize the overflow piping 430 with a cleaning solution. In practice, excess fluid from the soak tanks (not illustrated) flows through an inlet portion 440 of the overflow piping 430 and down the vertical overflow piping portion 450 to arrive at the overflow tank (not illustrated). It is common for the overflow piping 430 to become fouled (or contaminated) with particulates from the excess fluid as it flows through the overflow piping 430. Thus, the spiral nozzle 410 removes the undesirable fouling (or contamination) by receiving a cleaning solution from a sanitation line 420 and delivering the cleaning solution to the overflow piping 430. Although a spiral nozzle is depicted, any other nozzle known in the art may be implemented to achieve the desired sanitization of the overflow piping 430.

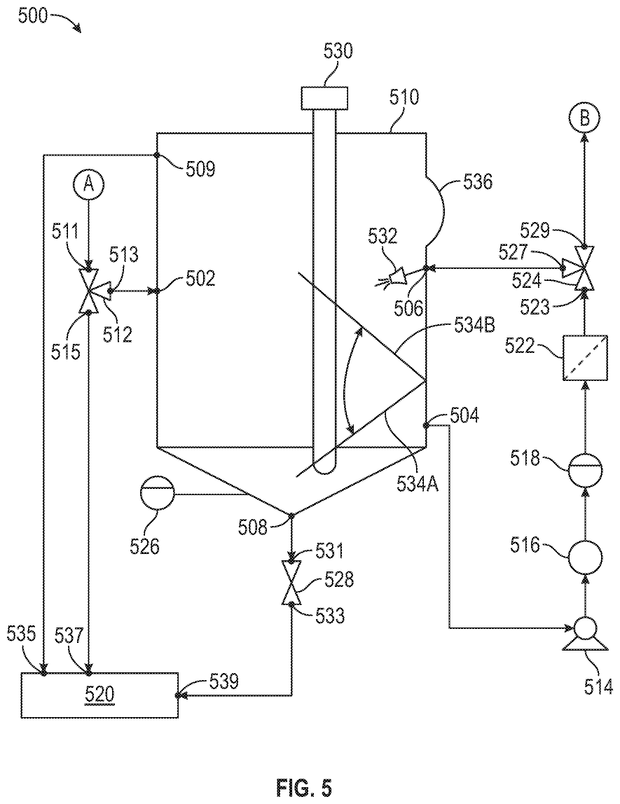

Turning to FIG. 5, an overflow tank 500 for use in a system for managing fluid overflow in a cooking system is depicted. The overflow tank 500 includes housing (alternatively referred to as a settling chamber) 510 having a first inlet 502, a second inlet 506, a first outlet 504, a second outlet 508, and a third outlet 509. The first inlet 502 is fluidly connected to a first outlet 513 of a fourth valve (alternatively referred to as an isolation valve) 512, which is configured to receive excess fluid A from the overflow piping of the set of soak tanks (not illustrated) via an inlet 511. The fourth valve 512 is configured to selectively deliver the excess fluid to the housing 510, an inlet 537 of the collection box 520 via a second outlet 515, or a combination thereof. In practice, the overflow tank 500 can be filled to 10-80% of the total volume, at least 10%, 20%, 30%, 40%, 50%, 60%, 70%, 80%, or any combination thereof. In some embodiments, the housing 510 can have a total volume of 200-600 gallons, 300-500 gallons, at least 300 gallons, 400 gallons, 500 gallons, 600 gallons, or any combination thereof.

The fourth valve 512 is in communication with a processor (not illustrated) that is configured to control the flow of the excess fluid through the fourth valve 512 depending on the desired circulation loop. The fourth valve 512 can also be activated manually. The first outlet 504 is in fluid communication with a pump 514, which is configured to deliver the excess fluid to an inlet 523 of a first valve (alternatively referred to as an agitation valve) 524. The pump 514 can be configured to deliver the excess fluid to the first valve 524 at a flow rate of 90-140 gpm, 100-130 gpm, 110-120 gpm, at least 90 gpm, 100 gpm, 110 gpm, 120 gpm, or any combination thereof.

The first valve 524 is configured to selectively deliver the excess fluid back to the second inlet 506 of the housing 510 via a first outlet 527 or deliver the excess fluid B to a fill valve (not illustrated) via a second outlet 529. The ability to recycle the fluid back to the kettles provides various advantages, such as providing heated water (compared to an external source) and a concentration of lime from the previous cooking cycles.

The overflow tank 500 can include one or more agitation nozzles 532 in fluid communication with the second inlet 506. The agitation nozzles 532 can be disposed at various locations in the housing 510 and are configured to agitate the excess fluid in the housing 510 to prevent fouling (e.g., lime build-up). In one example, the agitation nozzles 532 can be positioned at or near the bottom of the housing 510 and oriented in various directions to agitate the excess fluid. The first valve 524 is in communication with the processor (not illustrated) that is configured to control the flow of the excess fluid through the first valve 524.

In between the pump 514 and the first valve 524, the overflow tank 500 can include a flow meter 516, a pressure indicator transmitter 518, and a filter 522 in series. The pump 514, flow meter 516, and the pressure indicator transmitter 518 can be in communication with the processor (not illustrated) that is configured to use the readings to control the flow of the excess fluid. The filter 522 provides an additional opportunity to capture debris that might escape the housing 510 and prevent the rest of the system from becoming contaminated. The filter 522 can be purged manually, automatically, or continuously, depending on the application.

The overflow tank 500 also includes a debris monitor 530 that is configured to detect when a threshold level of debris accumulates in the housing 510. The debris monitor can include a sinking debris monitor 530 that is configured to detect and manage debris that sinks in the fluid contained in the overflow tank 500. Examples of the debris monitor 530 can include vibrating rod sensors, vibrating fork sensors, paddle sensors, capacitance sensors, ultrasonic sensors, optical sensors, conductivity sensors, pressure sensors, or any other sensor known in the art for detecting debris. In one embodiment, the debris monitor 530 is a vibrating level switch that is configured to detect granulated bulk solids in the housing 510. In at least one embodiment, the debris monitor 530 is a vibrating switch (or rod) that is configured to accurately detect particulates having a first threshold density (e.g., at least 15 g/l, at least 20 g/l, etc.), increasing the efficiency of the system. In at least another embodiment, the debris monitor 530 is a vibrating fork that is configured to accurately detect particulates having a second threshold density (e.g., at least 5 g/l, at least 8 g/l, etc.), increasing the efficiency of the system. One example of the vibrating level switches can include VEGAVIB or VEGAWAVE detectors.

When the debris monitor 530 detects a threshold level (or amount) of debris in the housing 510, a third valve (alternatively referred to as a drain valve) 528 that is fluidly connected to the second outlet 508 is configured to drain the debris (and/or excess fluid) to the collection box 520. An inlet 531 of the third valve 528 is in fluid communication with the second outlet 508 of the overflow tank 500, and an outlet 533 of the third valve is in fluid communication with an inlet 539 of the collection box 520. For example, the threshold level can be set to any level of the housing 510, including between 0-99% of the capacity, 10-90%, 20-80%, 30-70%, 40-60%, or any combination thereof. In the illustrative embodiment, the distance between the terminal end of the debris monitor 530 and the bottom of the housing 510 corresponds to the threshold level of the debris. The overflow tank 500 can also include a level transmitter 526 that is configured to transmit the level of the fluid, debris, or a combination thereof to a processor (not illustrated) for monitoring the fluid operation within the overflow tank 500. The debris monitor 530, the level transmitter 526, and the third valve 528 are in communication with the processor (not illustrated) that is configured to control the flow of the excess fluid. In at least one embodiment, the level transmitter 526 can be configured to shut off the pump 514 when the fluid level in the housing 510 is below a threshold level needed to supply the kettle with recycled water. Additionally, or alternatively, the level transmitter 526 can be configured to control the amount of water that is added for sanitation (e.g., via an automatic shut-off). The overflow tank 500 can also be configured to remove debris via timed purges. For example, the overflow tank 500 can be configured to drain the debris (and/or excess fluid) based on a timer. For example, the overflow tank 500 can be configured to drain the housing 510 every 5 minutes, 10 minutes, 15 minutes, 30 minutes, etc. The debris monitor 530 can also be configured to alert an operator if there has been a system malfunction. For example, if a soak tank has been significantly overfilled with corn and a significant (or large) amount of corn accumulates in the overflow tank 500, the catch box 520 would fill with the excess corn, preventing the excess corn from departing the housing 510. Examples of a significant amount of corn can be at least 60% of the capacity of the housing 510, at least 70%, at least 80%, at least 90%, or any combination thereof. The debris monitor 530 would continue to indicate the presence of debris even though the third valve 528 has been open longer than a pre-set time, which would result in the transfer pump from the kettles to the soak tanks being shut off automatically, preventing additional loss of corn. Additionally, an alarm can be triggered to notify operators of the malfunction.

The housing 510 can also include a movable baffle 534 that is configured to prevent debris from rising in the housing 510 and being distributed into the rest of the cooking system. As debris entering the housing 510 begins to sink, the movable baffle 534 prevents the sinking debris from entering the first outlet 504 and being circulated to the rest of the cooking system. The overflow tank 500 can also drain the excess fluid through the third outlet 509 to an inlet 535 of the collection box 520 in situations where the excess fluid level exceeds a threshold level. An access door 536 can be positioned in the housing 510 to enable an operator to open and sanitize the walls of the housing 510 and under the movable baffle 534 without needing to completely fill the system with water. As seen in the illustrative embodiment, the movable baffle 534 can be manipulated between a closed position 534A and an open position 534B, which can allow for sanitizing underneath the movable baffle 534.

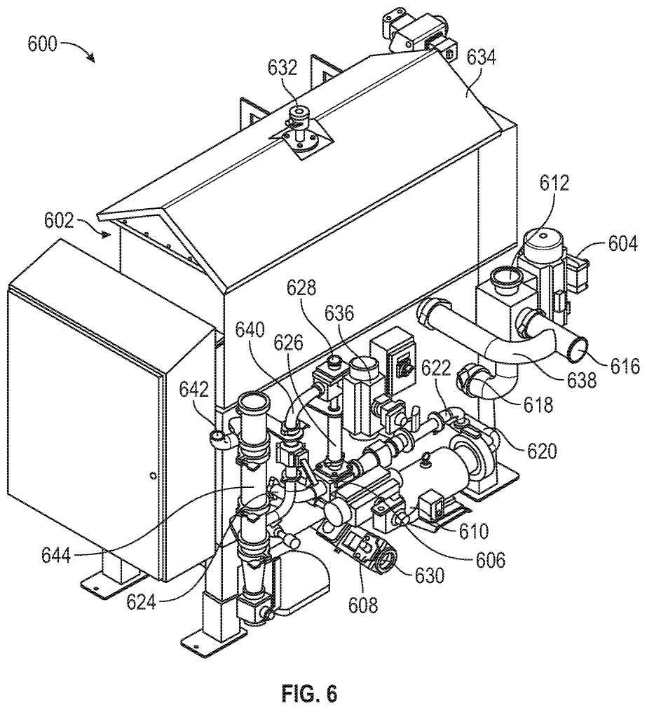

Turning to FIG. 6, a schematic of an overflow tank 600 that is described in FIG. 5 is depicted. The overflow tank 600 includes a housing 602 that is fluidly connected to a first inlet pipe 618, a second inlet pipe 624, a first outlet pipe 620, a second outlet pipe 638, and a third outlet pipe (not illustrated). The first inlet pipe 618 is fluidly connected to a fourth valve (or isolation valve) 604 that has an inlet 612 to receive excess fluid from the soak tanks. The fourth valve 604 is configured to selectively deliver the excess fluid to the first inlet pipe 618 or to an isolation outlet pipe 616 that transports the excess fluid to the collection box (not illustrated). The fourth valve 604 can be actuated either manually or automatically.

The first outlet pipe 620 is in fluid communication with a pump 610, which is connected to a pump outlet pipe 622 that is in fluid communication with the first valve (or agitation valve) 606. The first valve 606 is configured to selectively deliver the excess fluid to the second inlet pipe 624 or an outlet pipe 626 for delivering the excess fluid to the system. In configurations where the first valve 606 delivers the excess fluid to the outlet pipe 626, the excess fluid flows to a second valve (alternatively referred to as a fill valve) 636, where the second valve 636 is configured to selectively deliver the excess fluid to the kettles for subsequent cooking or the overflow piping for sanitization. For subsequent cooking, the second valve 636 delivers the excess fluid to outlet piping 628 that is in fluid communication with the kettles. For sanitization, the second valve 636 delivers the excess fluid to an outlet pipe 640, which can deliver the excess fluid to a filter 644 that delivers the excess fluid to an outlet pipe 642 in fluid communication with the overflow piping. The filter 644 can be a strainer configured to prevent bulk items or debris from being circulated back to the overflow piping. The second outlet pipe 638 can drain the excess fluid to the collection box in situations where the excess fluid level exceeds a threshold level in the overflow tank 600. The third outlet pipe is in fluid communication with a third valve (alternatively referred to as a drain valve) 608 that is configured to selectively deliver the debris (and/or excess fluid) to the collection box (not illustrated) via an outlet 630. The housing 602 can include a debris monitor 632 installed through the roof 634 of the overflow tank.

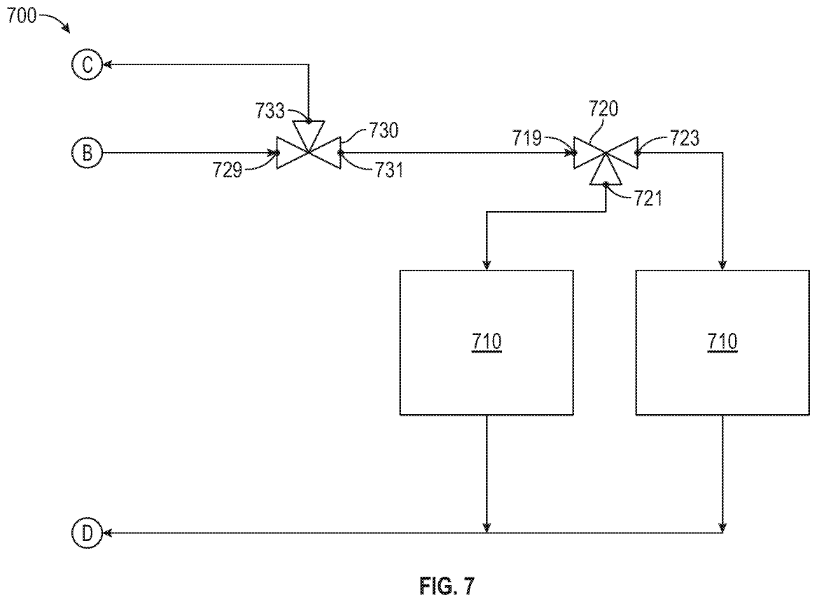

Referring to FIG. 7, a diagram 700 of kettles for use in a system for managing fluid overflow in a cooking system is depicted. An inlet 729 of a second valve (alternatively referred to as a fill valve) 730 is in fluid communication with the outlet of the agitation valve (not illustrated) and, depending on the desired circulation loop, configured to receive excess fluid or a cleaning solution B from the overflow tank depicted in FIG. 5. Under a sanitation loop, after the cleaning solution is dumped into the overflow tank and outputted B (FIG. 5), the second valve 730 receives the cleaning solution and is configured to selectively deliver the cleaning solution C via a second outlet 733 to the overflow piping. Under a recirculation loop, the second valve 730 receives the excess fluid and is configured to selectively deliver (via a first outlet 731) the excess fluid to an inlet 719 of a fifth valve (alternatively referred to as a diverter valve) 720, which can be configured to selectively deliver the excess fluid to the set of kettles 710. The fifth valve 720 is utilized in cooking systems with two kettles 710. Additional valve schemes can be utilized to supply any number of kettles 710 in a cooking system. In the illustrative embodiment, the fifth valve 720 selectively delivers the excess fluid to a first kettle 710 via a first outlet 721 and a second kettle 710 via a second outlet 723. Once sufficiently cooked, the set of kettles 710 can deliver the cooked mixture product D to the set of soak tanks. The second valve 730 and the fifth valve 720 are in communication with the processor (not illustrated) that is configured to control the flow of the excess fluid.

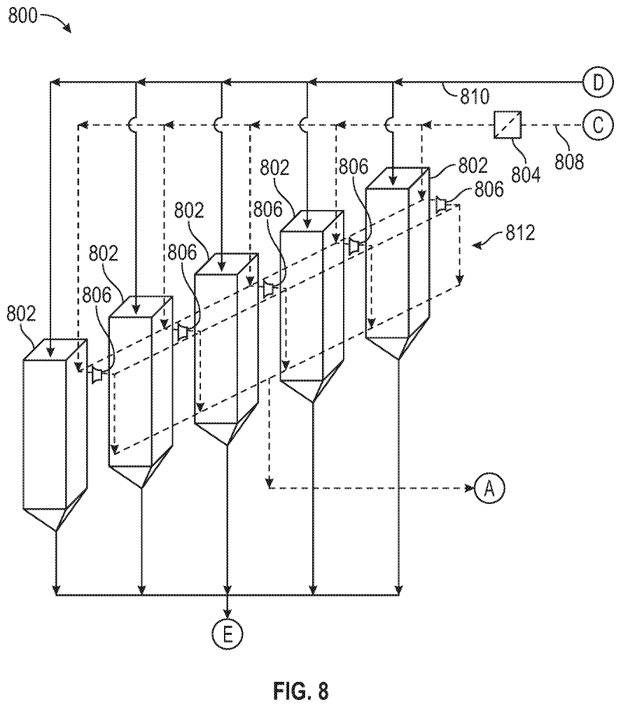

Turning to FIG. 8, a diagram 800 of a series of soak tanks 802 for use in a system for managing fluid overflow in a cooking system. The soak tanks 802 are configured to receive the cooked mixture product D via an inlet stream 810 for rehydration, hull loosening, and flavor development. The soak tanks 802 can then be drained to allow the debris E to pass to a corn washer. The soak tanks 802 are also configured to deliver an excess amount of fluid A to the overflow tank (not illustrated) via overflow piping 812. Additionally, the overflow piping 812 is configured to receive a cleaning solution C from the overflow tank piping 808 to sanitize the overflow piping system 812. As previously described herein, the overflow tanks 802 can include spiral nozzles 806 (or any other similar nozzles) that are in fluid communication with the overflow piping 812 and configured to deliver a cleaning solution into the overflow piping 812 at a high pressure to remove debris from the interior surfaces of the overflow piping 812. One or more filters 804 can be placed upstream of the soak tanks 802 and configured to remove any debris that might be delivered from the overflow tank piping 808.

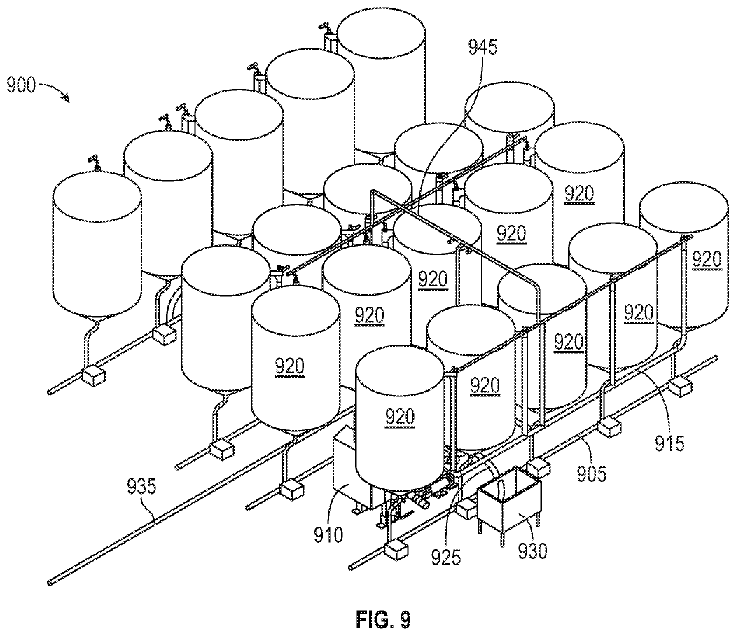

Referring to FIG. 9, a schematic 900 of soak tanks 920 and a collection box 930 connected to an overflow tank 910 are depicted. The soak tanks 920 are configured to drain the hydrated corn mixture through a drain line 905 to a corn washer (not illustrated), where the corn is separated from the hulls and lime. Under a sanitation loop configuration, the overflow piping 915 of the soak tanks 920 is configured to receive a cleaning solution from the overflow tank 910 via sanitation piping 945. The overflow tank 910 is also configured to deliver recycled fluid through a line 935 to the kettles (not illustrated). Additionally, the overflow tank 910 is configured to purge excess fluid through a line 925 to a collection box 930. In the illustrative embodiment, ten soak tanks 920 (five on each side) are in fluid communication with the overflow tank 910. The number of components can vary depending on the production needs of the system.

As used herein, the term “about” can be understood as the disclosed values varying by 20-25%, 15-20%, 10-15%, 5-10%, 1-5%, or any combination thereof from the listed values.

Additionally, the section headings herein are provided for consistency with the suggestions under 37 C.F.R. § 1.77 or to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that a particular technology is prior art to any embodiment(s) in this disclosure. Neither is the “Summary” a characterization of the embodiment(s) outlined in issued claims.

Furthermore, any reference in this disclosure to “invention” in the singular should not be used to argue that there is only a single point of novelty in this disclosure. Multiple embodiments may be set forth according to the limitations of the multiple claims issuing from this disclosure. Such claims accordingly define the embodiment(s) and their equivalents that are protected thereby. In all instances, the scope of such claims shall be considered on their own merits in light of this disclosure but should not be constrained by the headings set forth herein.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the preceding Detailed Description, it can be seen that various features may be grouped in a single embodiment to streamline the disclosure. This method of disclosure is not to be interpreted as reflecting an intention that the claimed embodiments require more features than are expressly recited in each claim. Instead, as the claims reflect, the inventive subject matter lies in less than all features of a single disclosed embodiment. Thus, the following claims are incorporated into the Detailed Description, with each claim standing on its own as a separate embodiment.

What is claimed is:

1. A system for managing fluid overflow in a food cooking system, the system comprising:
one or more kettles configured to contain a fluid for cooking a food product;
one or more soak tanks comprising a first inlet, a first outlet, and overflow piping, wherein the first inlet is fluidly connected to an outlet of the one or more kettles and configured to receive a cooked food product mixture, and wherein the first outlet is fluidly connected to the overflow piping; and
an overflow tank comprising a first inlet, a second inlet, and a first outlet, wherein the first inlet is fluidly connected to the overflow piping, the first outlet is fluidly connected to an inlet of a first valve, and the second inlet is fluidly connected to a first outlet of the first valve, further wherein the overflow tank is configured to:
receive an excess amount of fluid from the one or more soak tanks via the overflow piping, wherein the excess amount of fluid comprises the fluid and debris,
separate the fluid from the debris, and
deliver the separated fluid to the first valve;
wherein the first valve is configured to:
selectively deliver the separated fluid to an inlet of a second valve having a first outlet and a second outlet, wherein the first outlet of the second valve is fluidly connected to an inlet of the one or more kettles, and the second outlet of the second valve is fluidly connected to the overflow piping;
wherein the second valve is configured to:
selectively deliver the separated fluid to the one or more kettles for subsequent cooking, or
selectively deliver the separated fluid to the overflow piping for cleaning; and
a third valve and a collection box, wherein an inlet of the third valve is fluidly connected to a second outlet of the overflow tank, an outlet of the third valve is fluidly connected to a first inlet of the collection box, and wherein the overflow tank comprises a debris monitor, further wherein the third valve is configured to selectively deliver debris to the collection box when the debris monitor detects a threshold amount of debris in the overflow tank.

2. The system of claim 1, further comprising a fourth valve having an inlet fluidly connected to the overflow piping, a first outlet fluidly connected to the first inlet of the overflow tank and a second outlet fluidly connected to a second inlet of the collection box, wherein the fourth valve is configured to:
selectively deliver the excess amount of fluid to the overflow tank; or
selectively deliver the excess amount of fluid to the collection box.

3. The system of claim 2, further comprising a fifth valve having an inlet, a first outlet, and a second outlet, wherein the inlet of the fifth valve is fluidly connected to the first outlet of the second valve, further wherein the one or more kettles comprises a first kettle and a second kettle, an inlet of the first kettle being fluidly connected to the first outlet of the fifth valve, and an inlet of the second kettle being fluidly connected to the second outlet of the fifth valve, and further wherein the fifth valve is configured to selectively deliver the separated fluid to the first kettle, the second kettle, or a combination thereof.

4. The system of claim 3, wherein the one or more soak tanks comprises a first set of soak tanks and a second set of soak tanks, the first set of soak tanks comprising multiple soak tanks, and the second set of soak tanks comprising multiple soak tanks, wherein the first set of soak tanks are in fluid communication with the first kettle and the overflow tank, and wherein the second set of soak tanks are in fluid communication with the second kettle and the overflow tank.

5. The system of claim 2, wherein a third outlet of the overflow tank is in fluid communication with a third inlet of the collection box, further wherein the overflow tank is configured to discharge a portion of the excess amount of fluid when a volume of the excess fluid exceeds a threshold amount.

6. The system of claim 1, wherein the overflow tank further comprises a movable baffle disposed at a bottom portion within the overflow tank, and wherein the movable baffle is configured to prevent the debris from exiting the first outlet of the overflow tank.

7. The system of claim 1, wherein when the second valve selectively delivers the separated fluid to the overflow piping, the one or more soak tanks are partially filled.

8. The system of claim 7, wherein the overflow tank is configured to receive a cleaning solution to deliver to the overflow piping.

9. The system of claim 1, wherein the debris monitor detects a predetermined amount of debris, further wherein a transfer of food product from the one or more kettles to the one or more soak tanks is terminated, and further wherein an alarm is triggered indicating a malfunction in the system.

10. A system for managing fluid overflow in a food cooking system, the system comprising:
one or more kettles configured to contain a fluid for cooking a food product;
one or more soak tanks comprising a first inlet, a first outlet, and overflow piping, wherein the first inlet is fluidly connected to an outlet of the one or more kettles and configured to receive a cooked food product mixture, and wherein the first outlet is fluidly connected to the overflow piping; and
an overflow tank comprising a first inlet, a second inlet, a first outlet, a second outlet, and a debris monitor, wherein the first inlet is fluidly connected to the overflow piping and configured to receive an excess amount of fluid from the one or more soak tanks via the overflow piping, wherein the excess amount of fluid comprises the fluid and debris, and wherein the overflow tank is configured to separate the fluid from the debris;
a first valve comprising an inlet, a first outlet, and a second outlet, wherein the inlet of the first valve is fluidly connected to the first outlet of the overflow tank, the first outlet of the first valve is fluidly connected to the second inlet of the overflow tank;
a second valve fluidly connected to the second outlet of the first valve, wherein a first outlet of the second valve is fluidly connected to an inlet of the one or more kettles, and a second outlet of the second valve is fluidly connected to the overflow piping;
a third valve comprising an inlet and an outlet, wherein the inlet is fluidly connected to the second outlet of the overflow tank;
a collection box fluidly connected to the outlet of the third valve; and
wherein the first valve is configured to:
selectively deliver the separated fluid to the second valve;
wherein the second valve is configured to:
selectively deliver the separated fluid to the one or more kettles for subsequent cooking;
wherein the third valve is configured to selectively deliver debris to the collection box when the debris monitor detects a threshold amount of debris in the overflow tank.

11. The system of claim 10, further comprising a fourth valve having an inlet fluidly connected to the overflow piping, a first outlet fluidly connected to the first inlet of the overflow tank, and a second outlet fluidly connected to the collection box, wherein the fourth valve is configured to:
selectively deliver the excess amount of fluid to the overflow tank; or
selectively deliver the excess amount of fluid to the collection box.

12. The system of claim 11, further comprising a fifth valve having an inlet, a first outlet, and a second outlet, wherein the inlet of the fifth valve is fluidly connected to the first outlet of the second valve, further wherein the one or more kettles comprises a first kettle and a second kettle, an inlet of the first kettle being fluidly connected to the first outlet of the fifth valve, and an inlet of the second kettle being fluidly connected to the second outlet of the fifth valve, and further wherein the fifth valve is configured to selectively deliver the separated fluid to the first kettle, the second kettle, or a combination thereof.

13. The system of claim 12, wherein the one or more soak tanks comprises a first set of soak tanks and a second set of soak tanks, the first set of soak tanks comprising multiple soak tanks, and the second set of soak tanks comprising multiple soak tanks, wherein the first set of soak tanks are in fluid communication with the first kettle and the overflow tank, and wherein the second set of soak tanks are in fluid communication with the second kettle and the overflow tank.

14. The system of claim 10, wherein the overflow tank further comprises a third outlet in fluid communication with the collection box, wherein the overflow tank is configured to discharge a portion of the excess amount of fluid when a volume of the excess fluid exceeds a threshold amount.

15. The system of claim 10, wherein the overflow tank further comprises a movable baffle disposed at a bottom portion within the overflow tank, and wherein the movable baffle is configured to prevent the debris from exiting the first outlet of the overflow tank.

16. The system of claim 10, wherein when the second valve selectively delivers the separated fluid to the overflow piping, the one or more soak tanks are partially filled, and the overflow tank is configured to receive a cleaning solution to deliver to the overflow piping.

17. The system of claim 10, wherein the debris monitor detects a predetermined amount of debris, further wherein a transfer of food product from the one or more kettles to the one or more soak tanks is terminated, and further wherein an alarm is triggered indicating a malfunction in the system.
